(19) United States
(12) Patent Application Publication
(10) Pub. No.: US 2016/0070320 A1
(43) Pub. Date: Mar. 10, 2016

(54) Individual Device Reset and Recovery in a Computer

(71) Applicant: Microsoft Corporation, Redmond, WA (US)

(72) Inventors: Murali Rangayya Ravirala, Sammamish, WA (US); Youssef Maged Barakat, Bothell, WA (US); Jinsub Moon, Bellevue, WA (US)

(21) Appl. No.: 14/482,924

(22) Filed: Sep. 10, 2014

(51) Int. Cl. G06F 1/24; G06F 11/14

(52) U.S. Cl. CPC G06F 1/24; G06F 11/1441

(57) ABSTRACT

A computer includes multiple devices, each providing different functionality to the computer, such as communication functionality, input functionality, output functionality, and so forth. A reset control system of the computer manages resetting of the devices, resetting individual devices as appropriate rather than resetting the entire computer. In response to a malfunction of a particular device, the reset control system selects a set of one or more devices to reset. The devices to reset include the particular device as well as any other devices that will be affected by resetting the particular device (e.g., devices that cannot be powered down or reset separately from the particular device, or devices the operation of which relies on the particular device). The reset control system resets the set of one or more devices, and then adds each reset device back into the computer.

### BACKGROUND

As computing technology has advanced, the functionality that computers provide to their users has increased. This functionality includes various communication functionality, various input functionality, various output functionality, and so forth. While the increased availability of this functionality is beneficial to users, it is not without its problems. One such problem is that if there are any problems with or malfunctioning of this functionality, the entire computer is typically reset. This computer reset process can be time-consuming and tedious for the user, degrading the user experience.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, in a computer an indication is received that one device of multiple devices of the computer is to be reset due to a possible malfunction of the one device. A manner in which to reset the one device is determined, and in response to the indication the one device is reset in accordance with the determined manner and without resetting at least one other device of the computer. After being reset, the one device is added back into the computer.

In accordance with one or more aspects, a computer comprises multiple devices, each device being implemented at least in part in hardware, and a reset control system. The reset control system is configured to identify a set of devices in the computer to reset, the set of devices being a proper subset of the multiple devices, and the set of devices including a particular device that may be malfunctioning and further including one or more additional devices that will be affected by a reset of the particular device. The reset control system is further configured to determine how to reset each device in the set of devices, to reset each device in the set of devices without resetting other devices of the multiple devices, and to add each device in the set of devices device back into the computer.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is a block diagram illustrating an example computer implementing the individual device reset and recovery in a computer in accordance with one or more embodiments.

FIG. 2 illustrates an example system illustrating the dependency of devices on one another in accordance with one or more embodiments.

FIG. 3 is a flowchart illustrating an example process for implementing the individual device reset and recovery in a computer in accordance with one or more embodiments.

FIG. 4 illustrates an example system that includes an example computer that is representative of one or more systems and/or computers that may implement the various techniques described herein.

### DETAILED DESCRIPTION

Individual device reset and recovery in a computer is discussed herein. A computer includes multiple devices, each providing different functionality for the computer. These devices can provide various different functionality to the computer, such as communication functionality, input functionality, output functionality, and so forth. A reset control system of the computer manages resetting of the devices when the devices are malfunctioning, resetting individual devices as appropriate rather than resetting the entire computer.

In response to a malfunction or problem with a particular device, the reset control system selects a set of one or more devices to reset. The devices to reset include the particular device as well as any other devices that are laterally dependent or functionally dependent on the particular device. Two devices are laterally dependent if the two devices cannot be powered down or reset separately (e.g., two devices that are implemented as part of the same chip or package or otherwise share a power resource). Two devices are functionally dependent if the operation of one of the two devices relies on the other of the two devices.

The reset control system resets the set of one or more devices, which can be performed in various manners such as cycling a power line, pulsing a reset line, and so forth. Once reset, each of the set of one or more devices is treated as being removed (unplugged) from the computer, and then added back into (plugged back into) the computer.

Thus, when a problem with a device is detected, the reset control system advantageously resets only the particular device for which the problem was detected and other devices that are laterally dependent or functionally dependent on the particular device. Other devices of the computer are not reset, advantageously allowing continued use of those other devices during the reset process, and advantageously reducing the time taken for reset by reducing the number of devices that are reset.

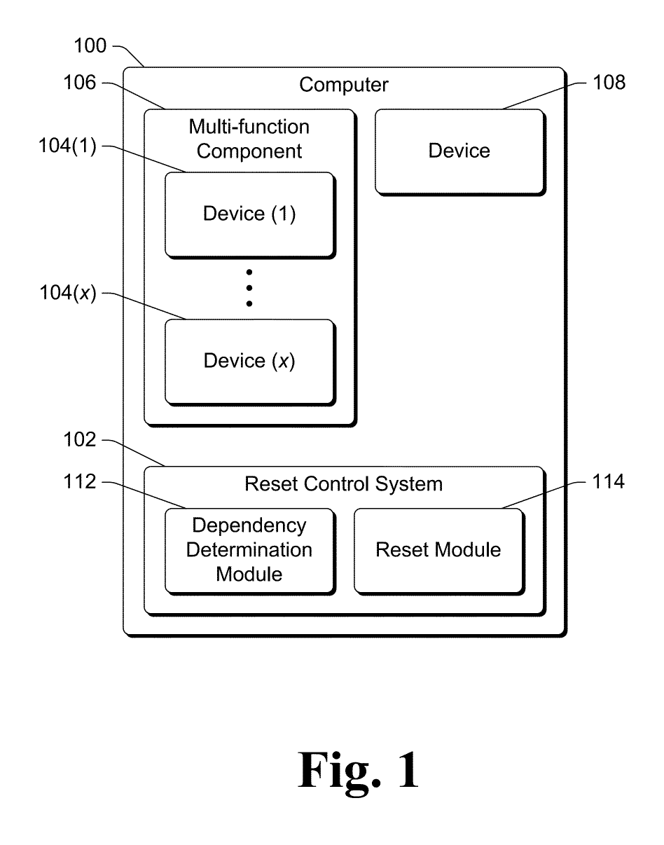

FIG. 1 is a block diagram illustrating an example computer 100 implementing the individual device reset and recovery in a computer in accordance with one or more embodiments. Computer 100 can take any of a variety of different forms, such as a desktop computer, a server computer, a laptop or netbook computer, a tablet or phablet device, a wearable device (e.g., eyeglasses, watch), a notepad computer, a mobile station, an entertainment appliance, a set-top box communicatively coupled to a display device, a television or other display device, a cellular or other wireless phone (e.g., a smartphone), a game console, an automotive computer, and so forth. Thus, computer 100 may range from a full resource computer with substantial memory and processor resources (e.g., personal computers, game consoles) to a low-resource computer with limited memory and/or processing resources (e.g., traditional set-top boxes, hand-held game consoles).

The computer 100 includes a reset control system 102, multiple devices 104(1), . . . , 104(x) that are part of a multi-function component 106, and a device 108. Each device 108 can provide any of a variety of different functionality to the computer 100, such as communication functionality allowing the computer to communicate with other devices, input functionality allowing the computer 100 to receive inputs from users of the computer 100, output functionality allowing data or information to be output by the computer 100, and so forth. A device 108 can be a communication device, for example, a wireless networking (e.g., Wi-Fi) device, a short range communication (e.g., Bluetooth, infrared) device, a modem device, a satellite navigation system (e.g., Global Positioning System (GPS), Galileo positioning system) device, and so forth. A device 108 can be an input device, such as a microphone device, a motion detection device that detects changes in motion of the computer 100, a touch device that senses a user or object touching the computer 100, a keyboard device, a mouse or other cursor control device, and so forth. A device 108 can be an output device, such as a printer device that generates hard copies of data or information, a display device that displays data or information on a screen, a motion device that provides haptic feedback, a speaker that plays back data or information audibly, and so forth.

Some devices are single-function devices, such as device 108. A single-function device refers to a device that is packaged by itself and separate from other devices, such as a standalone GPS device, a standalone modem, and so forth. Other devices are part of a multi-function component, such as devices 104(1), . . . , 104(x) being part of multi-function component 106. A multi-function component refers to a component that packages together the functionality of multiple devices into a single package, such as a single integrated circuit (IC) chip. The different devices in the single package typically share the same power resource (e.g., power line or reset line), resulting in the multiple different devices in the single package not being able to be reset independently. The power resource as used herein refers to an input to the device that is used to reset the device, such as a power rail or power line, a reset line, and so forth.

Each device 104(1), . . . , 104(x), and 108 is implemented using hardware, software, and/or firmware. A device typically includes a device driver implemented in software, which operates as an interface allowing other programs on the computer 100 (e.g., the operating system (OS)) to access the hardware of the device. Although the devices 104(1), . . . , 104(x), and 108 are illustrated and discussed herein as being part of or in the computer 100, a device can alternatively be external to but communicatively coupled to (e.g., using a wired or wireless communication channel) the computer 100. The techniques discussed herein apply analogously to devices that are external but communicatively coupled to the computer 100.

The reset control system 102 includes various modules or components in the computer 100, and can be tied to the computer 100 (e.g., integrated into the platform of the computer 100). The reset control system 102 includes a dependency determination module 112 and a reset module 114. The dependency determination module 112 determines which devices of the computer 100 are dependent on which other devices of the computer 100. A device can be laterally dependent or functionally dependent on another device, as discussed in more detail below. The reset module 114 manages resetting of one or more devices of the computer 100. In response to a malfunction or problem with a particular device, the reset module 114 selects a set of one or more devices to reset. The one or more devices to reset include the particular device as well as any other devices that are laterally dependent or functionally dependent on the particular device as determined by the dependency determination module 112.

The dependency determination module 112 determines which devices in the computer 100 are affected by reset of which other devices in the computer 100. A device A is affected by reset of a device B if the device A is laterally or functionally dependent on the device B. Two devices are laterally dependent if the two devices cannot be powered down or reset separately. A variety of different situations can exist in which two devices cannot be powered down or reset separately, such as situations in which the two devices are implemented as part of the same IC chip or package, situations in which the two devices share a power resource (e.g., the same power rail or power line of the computer provides power to both devices, both devices share the same reset line).

The lateral dependency of two devices can be determined in one or more of a variety of different manners. In one or more embodiments, the lateral dependency of two devices is identified to the dependency determination module 112 by firmware of the computer 100. The firmware can have knowledge of the power resources of two devices and make this knowledge available to the dependency determination module 112. This knowledge can be used to identify whether the two devices are laterally dependent—each device having the same power resource is laterally dependent on each other device having that same power resource. The firmware can store the knowledge in a register or other location accessible to the dependency determination module 112, or alternatively invoke a function (e.g., an application programming interface (API) method) of the dependency determination module 112 to provide the knowledge to the dependency determination module 112.

Alternatively, the lateral dependency of two devices can be identified in other manners. For example, a device driver of the device may have knowledge of the lateral dependency of two devices, and make this knowledge available to the dependency determination module 112. The device driver can make the knowledge available to the dependency determination module 112 in different manners, such as storing the knowledge in a registry or other data store accessible to the dependency determination module 112, invoking a function (e.g., an API method) of the dependency determination module 112 to provide the knowledge to the dependency determination module 112, and so forth.

By way of another example, the dependency determination module 112 can monitor various activities of the devices in the computer 100 and determine lateral dependencies of devices based on these monitored activities. These monitored activities can include, for example, functions of the operating system invoked by a device driver of a device, functions of a device driver of one device that are invoked by functions of a device driver of another device, registers or data stores accessed by the device driver of a device, events or messages broadcast or otherwise communicated by a device driver of a device, and so forth. E.g., if a device driver of device A invokes a particular function of a device driver of device B, then the dependency determination module 112 can determine that the device A and the device B are laterally dependent on one another.

In addition to lateral dependency, devices can be functionally dependent. Two devices are functionally dependent if the operation of one of the two devices relies on the other of the two devices. A variety of different situations can exist in which the operation of one device relies on another device. For example, the device driver of one device may rely on various functions or settings of the device driver of another device, one device driver may be a process spawned by another device driver (in which case the spawned device driver is functionally dependent on the device driver from which it was spawned), a composite device may enumerate one or more child devices (in which case each child device is functionally dependent on the device from which it was enumerated), and so forth.

The functional dependency of two devices can be determined in one or more of a variety of different manners. In one or more embodiments, the functional dependency of two devices is identified to the dependency determination module 112 by firmware of the computer 100. The firmware can have knowledge of the functional dependency of two devices, such as knowledge that the device driver of one device relies on functions or settings of the device driver of another device, and make this knowledge available to the dependency determination module 112. The firmware can store the knowledge in a register or other location accessible to the dependency determination module 112, or alternatively invoke a function (e.g., an API method) of the dependency determination module 112 to provide the knowledge to the dependency determination module 112.

Alternatively, the functional dependency of two devices can be identified in other manners. For example, a device driver of the device may have knowledge of the functional dependency of two devices, and make this knowledge available to the dependency determination module 112. The device driver can make the knowledge available to the dependency determination module 112 in different manners, such as storing the knowledge in a registry or other data store accessible to the dependency determination module 112, invoking a function (e.g., an API method) of the dependency determination module 112 to provide the knowledge to the dependency determination module 112, and so forth.

By way of another example, the dependency determination module 112 can monitor various activities of the devices in the computer 100 and determine functional dependencies of devices based on these monitored activities. These monitored activities can include, for example, which device drivers are processes spawned by which other device drivers, functions of the operating system invoked by a device driver of a device, functions of a device driver of one device that are invoked by functions of a device driver of another device, registers or data stores accessed by the device driver of a device, events or messages broadcast or otherwise communicated by a device driver of a device, and so forth. E.g., if a device driver of device A spawns a process that is a device driver of device B, then the dependency determination module 112 can determine that the device B is functionally dependent on the device A.

Additionally, an ordering of functional dependency can be determined by the dependency determination module 112. The ordering of functional dependency refers to which devices are dependent on which other devices. For example, if a device driver of device A spawns a process that is a device driver of device B, then the device B is functionally dependent on the device A, but the device A is not functionally dependent on the device B. The ordering of functional dependency allows devices being reset to be removed in order of dependency (e.g., following the previous example, so that the device B is removed prior to removal of the device A), as discussed in more detail below.

In one or more embodiments, the computer 100 supports the Advanced Configuration and Power Interface (ACPI) specification, such as the ACPI specification Revision 5.1 (July 2014), which establishes interfaces enabling OS-directed power management. The ACPI specification can be expanded to include a new member (e.g., a power resource member named _PRR) that resides in the device description of the device. This new member is an object or other data structure that points to or otherwise identifies a power resource of the device. This _PRR member is used by the dependency determination module 112 to determine the power resource for the device. If no value is present for the _PRR member of a device, then the dependency determination module 112 uses a default power resource as the determined power resource for the device. This default power resource can be, for example, a _PR3 resource of the ACPI specification, which is a power resource for the D3 power state of the ACPI specification (a power state in which power has been removed from the device).

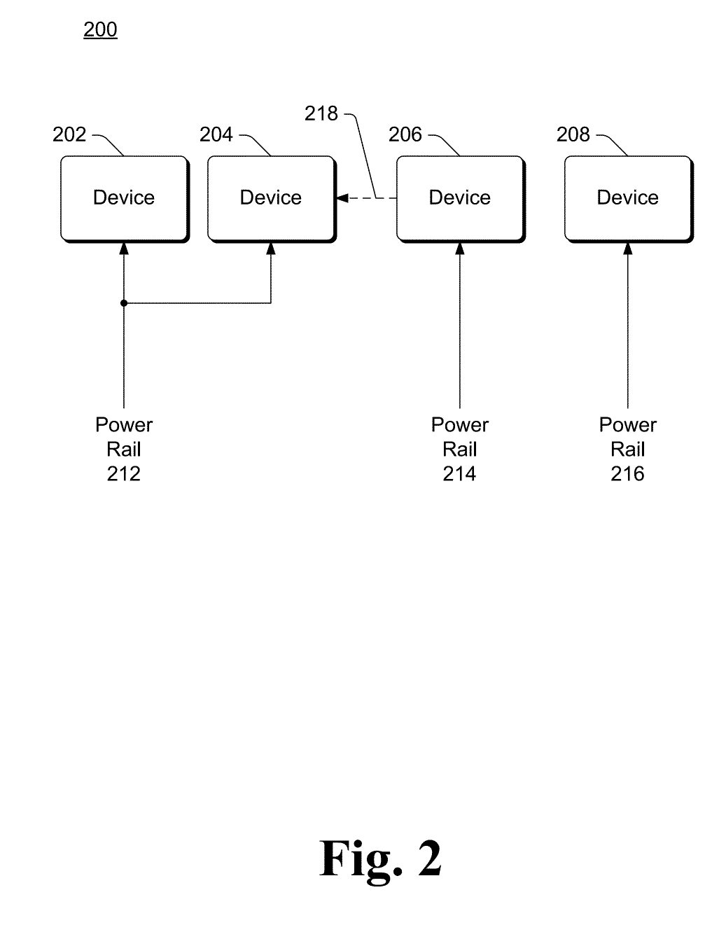

FIG. 2 illustrates an example system 200 illustrating the dependency of devices on one another in accordance with one or more embodiments. The system 200 includes four devices: device 202, device 204, device 206, and device 208. The system 200 also includes three power resources: power rail 212, power rail 214, and power rail 216. Each power rail 212, 214, and 216 is a hardware line or wire providing power to devices. The power rail 212 provides power to the device 202 and the device 204, and the devices 202 and 204 can be reset by toggling the power rail 212. The power rail 214 provides power to the device 206, and the device 206 can be reset by toggling the power rail 214. The power rail 216 provides power to the device 208, and the device 208 can be reset by toggling the power rail 216. The device 206 is also functionally dependent on the device 204, as illustrated by dashed arrow 218.

In the event of a malfunction of the device 204, the dependency determination module 112 of FIG. 1 determines a set of devices in the system 200 to reset. The device 204 has been identified as the device that is malfunctioning, so the device 204 is included in the set of devices to reset. The device 206 is functionally dependent on the device 204, so the device 206 is included in the set of devices to reset. The device 202 is laterally dependent on the device 204 (due to the device 202 and device 204 sharing the same power resource—power rail 212), so the device 202 is included in the set of devices to reset. The device 208, however, is neither laterally nor functionally dependent on any of the devices 202, 204, and 206. Accordingly, the device 208 is not included in the set of devices to reset.

Returning to FIG. 1, the reset module 114 manages resetting of one or more devices of the computer 100. In response to a malfunction or problem with a particular device, the reset module 114 selects a set of one or more devices to reset, as discussed above. Each of the devices in the selected set of one or more devices can be reset in the same manner, or alternatively different ones of the devices can be reset in different manners. A device can be reset in various different manners, such as by activating a reset line input to the hardware of the device (e.g., toggling the reset line), toggling a power rail or power line providing power to the device (e.g., turning off and subsequently turning on power to the device via the power rail, also referred to as power-cycling the power rail or power line), issuing a command via one or more input pins or ports of the device, and so forth.

The reset module 114 can determine the manner in which each device of the computer 100 is reset in any of a variety of different manners. In one or more embodiments, the manner in which a device is reset (also referred to as how the device is reset) is identified to the reset module 114 by firmware of the computer 100. The firmware can have knowledge of the manner in which to reset the device, and can make this knowledge available to the reset module 114. The firmware can store the knowledge in a register or other location accessible to the reset module 114, or alternatively invoke a function (e.g., an API method) of the reset module 114 to provide the knowledge to the reset module 114.

Alternatively, the manner in which a device is reset can be identified in other manners. For example, a device driver of the device may have knowledge of the manner in which the device is reset, and make this knowledge available to the reset module 114. The device driver can make the knowledge available to the reset module 114 in different manners, such as storing the knowledge in a registry or other data store accessible to the reset module 114, invoking a function (e.g., an API method) of the reset module 114 to provide the knowledge to the reset module 114, and so forth.

In embodiments in which the computer 100 supports the ACPI specification, such as the ACPI specification Revision 5.1 (July 2014), the ACPI specification can be expanded to include a new member (e.g., a reset member named _RST) that resides in the device description of the device. This new member is an object or other data structure that points to or otherwise identifies the procedure to reset the device. This _RST member is used by the reset module 114 to determine how to reset the device. If no value is present for the _RST member of a device, then the reset module 114 uses a default reset procedure for the device. This default reset procedure can be, for example, toggling the D3 power resource (e.g., by calling the _OFF method of a _PR3 resource of the ACPI specification, followed by calling the _ON method of the _PR3 resource).

It should be noted that the reset control system 102 provides a unified interface for resetting devices in the computer 100. The determination of which devices are dependent on which other devices, and the determination of how to reset the devices, is obtained by the reset control system 102 as discussed above. These determinations are advantageously made by the reset control system 102 regardless of the bus type or configuration of the device in the computer 100. Further, the device drivers of the devices need not have knowledge of the dependencies of devices on one another. If the device drivers have such knowledge then the dependency determination module 112 can use such knowledge, but the dependency determination module 112 need not rely on the device drivers having such knowledge.

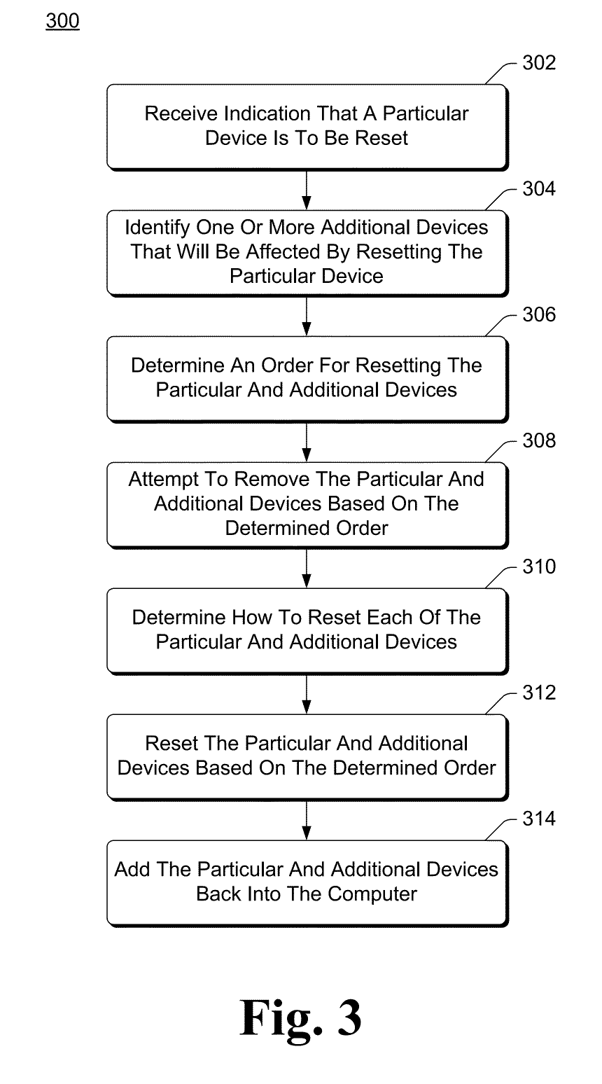

FIG. 3 is a flowchart illustrating an example process 300 for implementing the individual device reset and recovery in a computer in accordance with one or more embodiments. Process 300 is carried out by a reset control system, such as reset control system 102 of FIG. 1, and can be implemented in software, firmware, hardware, or combinations thereof. Process 300 is shown as a set of acts and is not limited to the order shown for performing the operations of the various acts. Process 300 is an example process for implementing the individual device reset and recovery in a computer; additional discussions of implementing the individual device reset and recovery in a computer are included herein with reference to different figures.

In process 300, an indication that a particular device is to be reset is received (act 302). A particular device is to be reset if the device is malfunctioning, which can be determined using any of a variety of public or proprietary techniques. For example, a device driver of the device may monitor hardware of the device to identify malfunctioning of the hardware, and indicate a device reset is to occur in response to the hardware malfunctioning. By way of another example, a module of the operating system may monitor the device to identify malfunctioning of the device, and indicate a device reset is to occur in response to the device malfunctioning.

One or more additional devices that will be affected by resetting the particular device are identified (act 304). These one or more additional devices are any other devices that are laterally dependent or functionally dependent on the particular device. These laterally dependent or functionally dependent devices can be determined in a variety of different manners as discussed above. The particular device indicated in act 302 as well as the one or more additional devices identified in act 304 are a set of devices to be reset. The set of devices is a subset of the multiple devices in the computer and is less than all of the multiple devices in the computer (the set of devices is thus also referred to as a proper subset of the multiple devices in the computer).

An order for resetting the particular and additional devices is also optionally determined (act 306). This order can be determined based on which devices are functionally dependent on which other devices. The order for resetting is determined so that a device A is reset before a device B if the device A is functionally dependent on the device B. For example, the device driver of the device A may rely on various functions or settings of the device driver of the device B, in which case the order for resetting is determined so that the device A is reset prior to the device B being reset. The ordering for resetting extends analogously to any arbitrary depth. For example, the device driver of the device A may rely on various functions or settings of the device driver of the device B, the device driver of the device B may rely on various functions or settings of the device driver of a device C, and the device driver of the device C may rely on various functions or settings of the device driver of a device D, in which case the order for resetting is determined so that the device A is reset prior to the device B being reset, the device B is reset prior to the device C being reset, and the device C is reset prior to the device D being reset.

The reset control system attempts to remove each of the particular and additional devices (act 308). Attempting to remove a device refers to communicating a removal request to the device driver for the device. The removal request is a request for the device driver to remove the device from the computer, treating the device as if it had been physically unplugged or otherwise removed from the computer (although not having the device physically unplugged or otherwise physically removed from the computer). In response to the removal request, the device driver can perform any functions desired by the device driver to prepare the device to be reset. For example, the device driver can gracefully terminate user sessions, dispose of or store any desired state of the device, and so forth.

The order in which the reset control system attempts to remove the particular and additional devices is the order determined in act 306. Thus, in act 308, if a device A is functionally dependent on a device B, then the reset control system attempts to remove the device A prior to attempting to remove the device B.

It should be noted that the device driver need not perform any actions in response to the removal request in act 308. The device driver may be malfunctioning, or may simply not desire to perform any actions in response to the removal request. Process 300 proceeds to act 310 regardless of whether the removal requests are received or acted upon by the device driver.

The reset control system determines how to reset each of the particular and additional devices (act 310). This determination can be made by the reset module 114 in any of a variety of different manners as discussed above. The determination in act 310 can be performed at different times. For example, the determination in act 310 can be performed as devices are added to the computer, can be performed during times of low system usage (e.g., low processor usage), can be performed in response to the receipt of the indication that the particular device is to be reset in act 302 or the identification of one or more additional devices in act 304, and so forth.

The particular and additional devices are reset (act 312). Each of the particular and additional devices is reset in the manner determined in act 310, and different ones of the particular and additional devices can be reset in the same or different manners. The particular and additional devices are reset in the order determined in act 306. Thus, in act 312, if a device A is functionally dependent on a device B, then the device A is reset prior to the device B. It should be noted that the particular and additional devices are reset in act 312 without resetting any of the other devices in the computer. Thus, devices in the computer are selectively reset—individual devices that are affected by resetting the particular device are reset, but these devices are reset in the absence of other devices in the computer being reset.

The particular and additional devices that were reset in act 312 are added back into the computer (act 314). Adding the particular and additional devices back into the computer refers to simulating the particular and additional devices being unplugged from the computer and then re-plugged into the computer. The bus drivers or other modules of the operating system support plug and play functionality, allowing devices to be plugged into the computer and automatically configured for operation in the computer. This support is leveraged by the reset control system, so no additional driver need be created and no changes to the device drivers of the particular and additional devices need be made in order to support the adding of the particular and additional devices back into the computer. These bus drivers refer to drivers that are responsible for detecting the presence of one or more devices on a bus (a physical bus or logical bus) and enumerating the one or more devices to the system (e.g., the operating system of the computer).

In act 314, the particular and additional devices are simulated as being unplugged from the computer. The reset module instructs the bus drivers or other modules of the operating system to report the particular and additional devices as missing, which causes the device drivers of the particular and additional devices to de-allocate information of the particular and additional devices as if they were physical unplugged from the computer, effectively clearing device states in the operating system for the particular and additional devices. The reset module also instructs the bus drivers or other modules of the operating system to, after reporting the particular and additional devices missing, report the particular and additional devices as present again. Reporting the particular and additional devices present again causes the bus drivers or other modules of the operating system to re-enumerate the particular and additional devices as if they were physically plugged back into the computer. The device drivers of the particular and additional devices reinitialize their information and data for the particular and additional devices, allowing the particular and additional devices to resume operation as if they were just physically plugged into the computer. The malfunctioning device is thus recovered from its malfunctioning state, and is able to resume operation.

It should be noted that in some situations the bus driver may not support having a device power-cycled while the computer is running. This situation is addressed in acts 312 and 314 by sequencing the actions so that the reset module instructs the bus drivers or other modules of the operating system to report the particular and additional devices as missing, and after this instruction is provided the particular and additional devices are reset (optionally after receiving confirmation of receipt of the instruction from the bus drivers or other modules of the operating system, or after waiting a threshold amount of time after providing this instruction to the bus drivers or other modules of the operating system). This instruction gives the bus drivers or other modules of the operating system the opportunity to prepare for the device being power-cycled. The reset module also instructs, after resetting the particular and additional devices, the bus drivers or other modules of the operating system to report the particular and additional devices as present again.

Process 300 is discussed with reference to receiving an indication that a particular device is to be reset if the device is malfunctioning. It should be noted that situations can arise in which two or more devices malfunction at substantially the same time, and the malfunction of these two or more device can be determined using any of a variety of public or proprietary techniques. For example, two devices may be packaged onto the same IC chip and the whole IC chip may malfunction, resulting in drivers for both of the devices detecting and indicating that the two devices are malfunctioning. If two or more devices malfunction at substantially the same time, acts 304-314 may be performed for the two or more devices concurrently (e.g., each device being a particular device, and the acts referring to a particular device being performed for each of the two or more devices), or alternatively sequentially (e.g., acts 304-314 may be performed for one of the two or more devices, and then acts 304-314 performed for another of the two or more devices, and so forth).

The techniques discussed herein support various different usage scenarios. In the event a device malfunctions in a computer, only the device and additional devices that are affected by resetting the device are reset. Other devices in the computer are not reset, advantageously improving usability of the computer by allowing the devices not being reset to continue functioning, resulting in faster resetting of the computer from the user's perspective. By selectively resetting the devices as discussed herein, those devices that are affected by resetting a particular device are requested to remove themselves, advantageously allowing such devices to gracefully terminate user sessions and manage data of the device.

The techniques discussed herein also support function-level device reset (FLDR), where a device can be reset just by itself if supported by the device and/or the bus. However, this FLDR of a device is transparent to functional and lateral dependencies of the device, the FLDR assuming that the device can be reset without needing to reset functionally or laterally dependent devices. Such function-level device reset can be used in conjunction with the processes and infrastructure discussed herein.

Although particular functionality is discussed herein with reference to particular modules, it should be noted that the functionality of individual modules discussed herein can be separated into multiple modules, and/or at least some functionality of multiple modules can be combined into a single module. Additionally, a particular module discussed herein as performing an action includes that particular module itself performing the action, or alternatively that particular module invoking or otherwise accessing another component or module that performs the action (or performs the action in conjunction with that particular module). Thus, a particular module performing an action includes that particular module itself performing the action and/or another module invoked or otherwise accessed by that particular module performing the action.

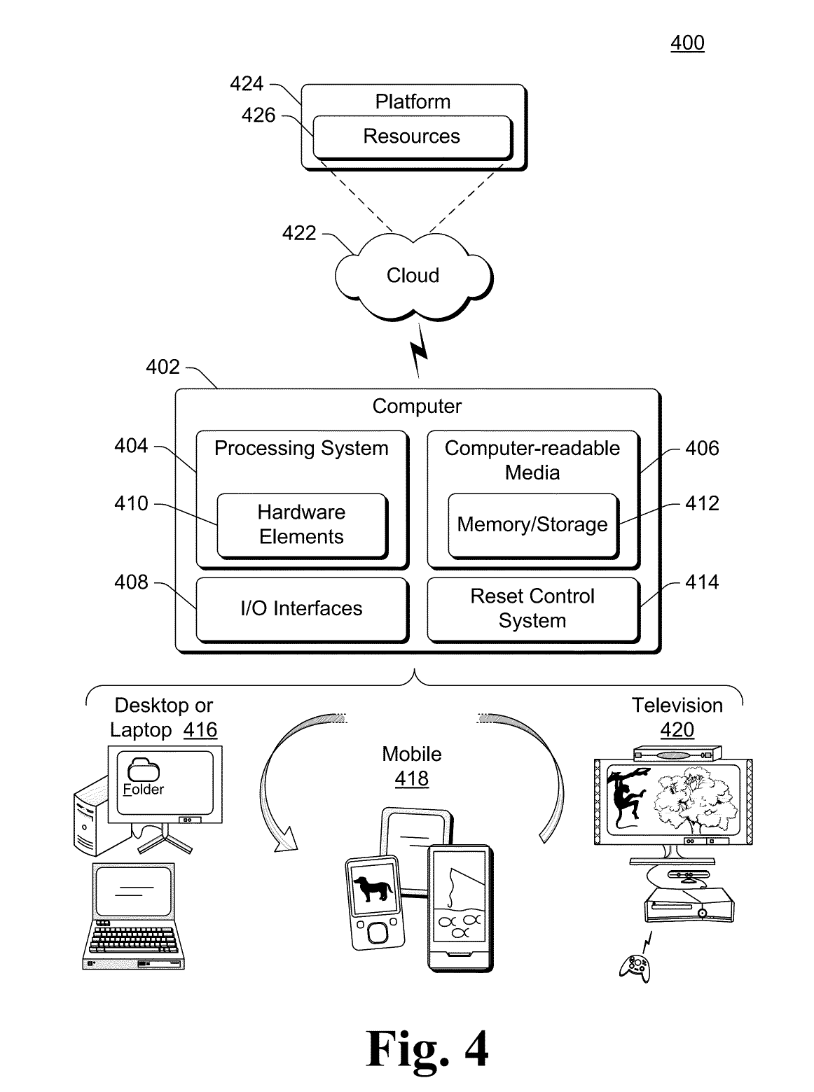

FIG. 4 illustrates an example system generally at 400 that includes an example computer 402 that is representative of one or more systems and/or computers that may implement the various techniques described herein. The computer 402 may be, for example, a server of a service provider, a device associated with a client (e.g., a client device), an on-chip system, a mobile-broadband chip, and/or any other suitable computer or computing system.

The example computer 402 as illustrated includes a processing system 404, one or more computer-readable media 406, and one or more I/O Interfaces 408 that are communicatively coupled, one to another. Although not shown, the computer 402 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 404 is representative of functionality to perform one or more operations using hardware. Accordingly, the processing system 404 is illustrated as including hardware elements 410 that may be configured as processors, functional blocks, and so forth. This may include implementation in hardware as an application specific integrated circuit or other logic device formed using one or more semiconductors. The hardware elements 410 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 406 is illustrated as including memory/storage 412. The memory/storage 412 represents memory/storage capacity associated with one or more computer-readable media. The memory/storage 412 may include volatile media (such as random access memory (RAM)) and/or nonvolatile media (such as read only memory (ROM), Flash memory, optical disks, magnetic disks, and so forth). The memory/storage 412 may include fixed media (e.g., RAM, ROM, a fixed hard drive, and so on) as well as removable media (e.g., Flash memory, a removable hard drive, an optical disc, and so forth). The computer-readable media 406 may be configured in a variety of other ways as further described below.

Input/output interface(s) 408 are representative of functionality to allow a user to enter commands and information to the computer 402, and also allow information to be presented to the user and/or other components or devices using various input/output devices. Examples of input devices include a keyboard, a cursor control device (e.g., a mouse), a microphone (e.g., for voice inputs), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computer 402 may be configured in a variety of ways as further described below to support user interaction.

The computer 402 also includes a reset control system 414. The reset control system 414 provides various device reset functionality, including selectively resetting devices in the computer 402 as discussed above. The reset control system 414 can implement, for example, the reset control system 102 of FIG. 1.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” “component”, and “system” as used herein generally represent software, firmware, hardware, or a combination thereof. The features of the techniques described herein are platform-independent, meaning that the techniques may be implemented on a variety of computing platforms having a variety of processors.

An implementation of the described modules and techniques may be stored on or transmitted across some form of computer-readable media. The computer-readable media may include a variety of media that may be accessed by the computer 402. By way of example, and not limitation, computer-readable media may include “computer-readable storage media” and “computer-readable signal media.”

“Computer-readable storage media” refers to media and/or devices that enable persistent storage of information and/or storage that is tangible, in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” refers to a signal-bearing medium that is configured to transmit instructions to the hardware of the computer 402, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, the hardware elements 410 and the computer-readable media 406 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 410. The computer 402 may be configured to implement particular instructions and/or functions corresponding to the software and/or hardware modules. Accordingly, implementation of modules as a module that is executable by the computer 402 as software may be achieved at least partially in hardware, e.g., through use of computer-readable storage media and/or hardware elements 410 of the processing system. The instructions and/or functions may be executable/operable by one or more articles of manufacture (for example, one or more computers 402 and/or processing systems 404) to implement techniques, modules, and examples described herein.

As further illustrated in FIG. 4, the example system 400 enables ubiquitous environments for a seamless user experience when running applications on a personal computer (PC), a television, and/or a mobile computer. Services and applications run substantially similar in all three environments for a common user experience when transitioning from one to the next while utilizing an application, playing a video game, watching a video, and so on.

In the example system 400, multiple computers are interconnected through a central computer. The central computer may be local to the multiple computers or may be located remotely from the multiple computers. In one or more embodiments, the central computer may be a cloud of one or more server computers that are connected to the multiple computers through a network, the Internet, or other data communication link.

In one or more embodiments, this interconnection architecture enables functionality to be delivered across multiple computers to provide a common and seamless experience to a user of the multiple computers. Each of the multiple computers may have different physical requirements and capabilities, and the central computer uses a platform to enable the delivery of an experience to the computers that is both tailored to the computer and yet common to all computers. In one or more embodiments, a class of target computers is created and experiences are tailored to the generic class of computers. A class of computers may be defined by physical features, types of usage, or other common characteristics of the computers.

In various implementations, the computer 402 may assume a variety of different configurations, such as for desktop or laptop 416, mobile 418, and television 420 uses. Each of these configurations includes computers that may have generally different constructs and capabilities, and thus the computer 402 may be configured according to one or more of the different computer classes. For instance, the computer 402 may be implemented as the desktop or laptop 416 class of a computers that includes a personal computer, desktop computer, a multi-screen computer, laptop computer, netbook, and so on.

The computer 402 may also be implemented as the mobile 418 class of computers that includes mobile computers, such as a mobile phone, portable music player, portable gaming device, a tablet computer, a multi-screen computer, and so on. The computer 402 may also be implemented as the television 420 class of computer that includes computers having or connected to generally larger screens in casual viewing environments. These computers include televisions, set-top boxes, gaming consoles, and so on.

The techniques described herein may be supported by these various configurations of the computer 402 and are not limited to the specific examples of the techniques described herein. This functionality may also be implemented all or in part through use of a distributed system, such as over a “cloud” 422 via a platform 424 as described below.

The cloud 422 includes and/or is representative of a platform 424 for resources 426. The platform 424 abstracts underlying functionality of hardware (e.g., servers) and software resources of the cloud 422. The resources 426 may include applications and/or data that can be utilized while computer processing is executed on servers that are remote from the computer 402. Resources 426 can also include services provided over the Internet and/or through a subscriber network, such as a cellular or Wi-Fi network.

The platform 424 may abstract resources and functions to connect the computer 402 with other computers. The platform 424 may also serve to abstract scaling of resources to provide a corresponding level of scale to encountered demand for the resources 426 that are implemented via the platform 424. Accordingly, in an interconnected computer embodiment, implementation of functionality described herein may be distributed throughout the system 400. For example, the functionality may be implemented in part on the computer 402 as well as via the platform 424 that abstracts the functionality of the cloud 422.

In the discussions herein, various different embodiments are described. It is to be appreciated and understood that each embodiment described herein can be used on its own or in connection with one or more other embodiments described herein.

Further aspects of the techniques discussed herein relate to one or more of the following embodiments.

A method implemented in a computer comprises: receiving an indication that one device of multiple devices of the computer is to be reset due to a possible malfunction of the one device; determining a manner in which to reset the one device; resetting, in response to the indication, the one device in accordance with the determined manner and without resetting at least one other device of the computer; and adding, after resetting the one device, the one device back into the computer.

In the above described method, the multiple devices including two or more devices that are part of a multi-function component of the computer, and the multiple devices further including one or more additional devices that are separate from the multi-function component.

In any one or more of the above described methods, the two or more devices that are part of the multi-function component including a modem device and a Wi-Fi device.

In any one or more of the above described methods, the determining further comprising determining a power resource of each of the multiple devices, the power resource of a device comprising an input to the device that is used to reset the device, and two or more of the multiple devices having different power resources.

In any one or more of the above described methods, further comprising determining a set of devices to reset, the set of devices including the one device as well as one or more additional devices that will be affected by a reset of the one device, and the resetting comprising resetting the set of devices in the absence of resetting other devices of the multiple devices.

In any one or more of the above described methods, the one or more additional devices that will be affected by a reset of the one device including devices that are laterally dependent on the one device, the determining further comprising determining that a device is laterally dependent on the one device in response to the device being unable to be powered down or reset separately from the one device.

In any one or more of the above described methods, the one device being part of a multi-function component of the computer, and the one or more additional devices that will be affected by a reset of the one device including one or more devices that are also part of the multi-function component.

In any one or more of the above described methods, the one or more additional devices that will be affected by a reset of the one device including devices that are functionally dependent on the one device, the determining further comprising determining that a device is functionally dependent on the one device in response to operation of the device relying on the one device.

In any one or more of the above described methods, further comprising determining an ordering of devices in the set of devices, the ordering including a first device that is functionally dependent on a second device being ordered for reset prior to the second device.

In any one or more of the above described methods, further comprising determining, for each device in the set of devices, how to reset the device, and two or more of the devices in the set of devices being reset in different manners.

In any one or more of the above described methods, further comprising communicating, prior to resetting the one device, a request to a device driver of the one device to remove the one device from the computer.

In any one or more of the above described methods, the multiple devices including two or more devices selected from the following: a wireless networking device, a satellite navigation system device, a short range communication device, and a modem device.

A computer comprises: multiple devices, each device being implemented at least in part in hardware; and a reset control system configured to identify a set of devices in the computer to reset, the set of devices being a proper subset of the multiple devices, the set of devices including a particular device that may be malfunctioning and further including one or more additional devices that will be affected by a reset of the particular device; determine how to reset each device in the set of devices; reset each device in the set of devices without resetting other devices of the multiple devices; and add each device in the set of devices device back into the computer.

In the above described computer, the one or more additional devices including devices that are unable to be powered down or reset separately from the one device.

In any one or more of the above described computers, the one or more additional devices being unable to be powered down or reset separately from the one device due to the one or more additional devices sharing a power rail or reset line with the one device.

In any one or more of the above described computers, the one or more additional devices including devices the operation of which relies on the one device.

In any one or more of the above described computers, the reset control system being further configured to: determine an order of devices in the set of devices, the order including a first device that relies on the operation of a second device being ordered for reset prior to the second device; and reset the devices in the set of devices in the determined order.

In any one or more of the above described computers, two or more of the devices in the set of devices being reset in different manners.

In any one or more of the above described computers, the reset control system being further configured to communicate, for each device in the set of devices and prior to resetting the device, a request to a device driver of the device to remove the device from the computer.

A method comprising, or a computer-readable storage medium having stored thereon multiple instructions that, responsive to execution by one or more processors of a computer, cause the one or more processors to perform acts comprising: receiving an indication that one device of multiple devices of the computer is to be reset due to a possible malfunction of the one device; identifying a set of devices to reset, the set of devices including the one device as well as one or more additional devices that will be affected by a reset of the one device, the one or more additional devices including devices that are unable to be powered down or reset separately from the one device, the one or more additional devices further including a device the operation of which is dependent on the one device; determining how to reset each device of the set of devices; resetting, in response to determining that the one device is to be reset, each device in the set of devices in the absence of resetting other devices of the multiple devices; and adding the set of devices back into the computer.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method implemented in a computer, the method comprising:
receiving an indication that one device of multiple devices of the computer is to be reset due to a possible malfunction of the one device;
determining a manner in which to reset the one device;
resetting, in response to the indication, the one device in accordance with the determined manner and without resetting at least one other device of the computer; and
adding, after resetting the one device, the one device back into the computer.

2. A method as recited in claim 1, the multiple devices including two or more devices that are part of a multi-function component of the computer, and the multiple devices further including one or more additional devices that are separate from the multi-function component.

3. A method as recited in claim 2, the two or more devices that are part of the multi-function component including a modem device and a Wi-Fi device.

4. A method as recited in claim 1, the determining further comprising determining a power resource of each of the multiple devices, the power resource of a device comprising an input to the device that is used to reset the device, and two or more of the multiple devices having different power resources.

5. A method as recited in claim 1, further comprising determining a set of devices to reset, the set of devices including the one device as well as one or more additional devices that will be affected by a reset of the one device, and the resetting comprising resetting the set of devices in the absence of resetting other devices of the multiple devices.

6. A method as recited in claim 5, the one or more additional devices that will be affected by a reset of the one device including devices that are laterally dependent on the one device, the determining further comprising determining that a device is laterally dependent on the one device in response to the device being unable to be powered down or reset separately from the one device.

7. A method as recited in claim 6, the one device being part of a multi-function component of the computer, and the one or more additional devices that will be affected by a reset of the one device including one or more devices that are also part of the multi-function component.

8. A method as recited in claim 5, the one or more additional devices that will be affected by a reset of the one device including devices that are functionally dependent on the one device, the determining further comprising determining that a device is functionally dependent on the one device in response to operation of the device relying on the one device.

9. A method as recited in claim 8, further comprising determining an ordering of devices in the set of devices, the ordering including a first device that is functionally dependent on a second device being ordered for reset prior to the second device.

10. A method as recited in claim 5, further comprising determining, for each device in the set of devices, how to reset the device, and two or more of the devices in the set of devices being reset in different manners.

11. A method as recited in claim 1, further comprising communicating, prior to resetting the one device, a request to a device driver of the one device to remove the one device from the computer.

12. A method as recited in claim 1, the multiple devices including two or more devices selected from the following: a wireless networking device, a satellite navigation system device, a short range communication device, and a modem device.

13. A computer comprising:
multiple devices, each device being implemented at least in part in hardware; and
a reset control system configured to
identify a set of devices in the computer to reset, the set of devices being a proper subset of the multiple devices, the set of devices including a particular device that may be malfunctioning and further including one or more additional devices that will be affected by a reset of the particular device;
determine how to reset each device in the set of devices;
reset each device in the set of devices without resetting other devices of the multiple devices; and
add each device in the set of devices device back into the computer.

14. A computer as recited in claim 13, the one or more additional devices including devices that are unable to be powered down or reset separately from the one device.

15. A computer as recited in claim 14, the one or more additional devices being unable to be powered down or reset separately from the one device due to the one or more additional devices sharing a power rail or reset line with the one device.

16. A computer as recited in claim 13, the one or more additional devices including devices the operation of which relies on the one device.

17. A computer as recited in claim 16, the reset control system being further configured to:
determine an order of devices in the set of devices, the order including a first device that relies on the operation of a second device being ordered for reset prior to the second device; and
reset the devices in the set of devices in the determined order.

18. A computer as recited in claim 13, two or more of the devices in the set of devices being reset in different manners.

19. A computer as recited in claim 13, the reset control system being further configured to communicate, for each device in the set of devices and prior to resetting the device, a request to a device driver of the device to remove the device from the computer.

20. A computer-readable storage medium having stored thereon multiple instructions that, responsive to execution by one or more processors of a computer, cause the one or more processors to perform acts comprising:
receiving an indication that one device of multiple devices of the computer is to be reset due to a possible malfunction of the one device;
identifying a set of devices to reset, the set of devices including the one device as well as one or more additional devices that will be affected by a reset of the one device, the one or more additional devices including devices that are unable to be powered down or reset separately from the one device, the one or more additional devices further including a device the operation of which is dependent on the one device;
determining how to reset each device of the set of devices;
resetting, in response to determining that the one device is to be reset, each device in the set of devices in the absence of resetting other devices of the multiple devices; and
adding the set of devices back into the computer.
